(19) United States
(12) Patent Application Publication
(10) Pub. No.: US 2003/0152407 A1
(43) Pub. Date: Aug. 14, 2003

(54) Cleaning apparatus and image forming apparatus

(75) Inventor: Fukashi Hatano, Ibaraki (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/358,210

(22) Filed: Feb. 5, 2003

(30) Foreign Application Priority Data
Feb. 8, 2002 (JP) 2002-033124

(51) Int. Cl. G03G 21/00

(52) U.S. Cl. 399/350; 399/358

(57) ABSTRACT

There is disclosed a cleaning apparatus which has a cleaning member for cleaning a surface of an image bearing member, a developer carrying member for carrying a developer cleaned by the cleaning member, a developer receiving member arranged below the cleaning member in a direction of gravity to receive the developer dropped from the cleaning member, and a developer carrying path for interconnecting the developer receiving member and the developer carrying member.

### BACKGROUND OF THE INVENTION

1. Field of the Invention

The present invention relates to a cleaning apparatus for removing a developer on an image bearing member, a copying machine provided with this cleaning apparatus, and an image forming apparatus such as a printer.

2. Related Background Art

Conventionally, as an image forming apparatus of this type, there has generally been used an image forming apparatus for sticking toner to an electrostatic latent image electrostatically formed on a surface of a photosensitive member as an image bearing member to form a toner image, and electrostatically transferring this toner image to a transferring material (sheet, transparent film or the like).

In such an image forming apparatus, toner remaining (residual toner) on the photosensitive member without being transferred to the transferring material in transferring must be sufficiently removed each time in order to form a next image (image formation). As its cleaning means, means for pressing a cleaning blade made of an elastic material such as urethane rubber into contact with the surface of the photosensitive member to remove the residual toner has been put into wide practical use.

However, from the viewpoint of prolonging a life of a high-speed machine, in the image forming apparatus using an a-Si (amorphous silicon) photosensitive member, it is necessary to remove not only the residual toner but also various foreign objects such as deposited organic materials or corona products caused by presence of high-pressure members etc. in the apparatus which may cause deterioration of image quality if stuck to the photosensitive member. These foreign objects cannot be removed completely only by the cleaning blade.

Therefore, in the case of the image forming apparatus using the a-Si photosensitive member and one component magnetic toner, integrally with the cleaning blade, a magnet roller may be arranged as removal assisting means in the vicinity thereof. That is, there has been used a method for removing various foreign objects in a slide-rubbing manner by using toner magnetism, collected toner and a magnetic brush formed in the magnet roller. The magnetic brush is uniformly formed by a toner coating amount regulating member.

Further, a constitution is employed where the toner coating amount regulating member and an end scraper are separately disposed and, through a gap between the two members, toner scratched off by the toner coating amount regulating member and the end scraper is smoothly sent to a waste toner carrying portion.

In addition to the foreign object removing operation, the aforementioned method has various advantages, such as prevention of so-called “blade tearing-off” which easily occurs when there is no toner at all on the surface of the photosensitive member by using the magnetic brush to supply toner little by little, and facilitation of toner removal by the blade by applying a mechanical force to the toner electrostatically stuck to the surface of photosensitive member to reduce a sticking force of the toner to the photosensitive member. The method has been effective to a certain extent in the image forming apparatus which uses only one component magnetic toner in order to obtain a black and white image.

Now, color toner in a multicolor image forming apparatus of two colors or more is usually prepared by mixing dyes or pigments in a transparent resin to make clear a color of a copy image, and it is often nonmagnetic toner. In the case of a constitution using only nonmagnetic toner including black toner, the residual toner is often removed by the aforementioned cleaning blade.

However, since control of toner concentration is not necessary for the one component magnetic toner, and a developing apparatus can be constituted to be simpler compared with two components, there have been seen examples of using it as black toner. In the case of such a constitution, if the cleaning apparatus having the magnet roller is applied, the color toner is not adsorbed by the magnet roller, which makes it impossible to prevent problems in a cleaning function.

A constitution which removes the magnet roller and depends only on the cleaning blade in order to coordinate the cleaning operation with the nonmagnetic toner is not advisable because of the aforementioned advantages of the magnet roller and a probably largest frequency of obtaining a black image.

That is, it is desired that cleaning of the nonmagnetic toner is carried out without losing the effects provided by the magnet roller in the cleaning of the magnetic toner.

Thus, when the nonmagnetic toner is actually collected in the cleaning apparatus comprising the magnet roller, first, the nonmagnetic toner is stuck to the magnetic toner on the magnet roller by the application of an electrostatic adsorbing force or van der Waals force to be removed. However, after supplying of the nonmagnetic toner to a certain extent, the toner is freed without being captured any more, and leaked to the outside. As a result, the toner may be scattered or stuck in a gap between the magnet rollers to damage the cleaning function, or rubbed by the blade to be fused on the photosensitive member.

That is, while the magnetic brush formed around the magnet roller has a capturing function of nonmagnetic toner of a given amount or lower, further supplying of the nonmagnetic toner causes sudden deterioration of the capturing function.

Therefore, as one of countermeasures, a method has been employed which prevents the deterioration of the cleaning function by supplying the magnetic toner to a cleaner at given intervals in accordance with a frequency of forming color images to reduce a ratio of the nonmagnetic toner.

However, according to the aforementioned conventional technology, the nonmagnetic toner is not completely bound by the magnet roller, and accumulated in a toner receiver below the magnet roller while a cleaning operation is repeated. As a result, a phenomenon called dripping occurs where the nonmagnetic toner is leaked from a toner container.

The toner scratched off by the toner coating amount regulating member is passed on the toner coating amount regulating member and guided to a waste toner carrying path, and then discharged to the outside of the machine by a waste toner carrying screw. However, while the magnetic brush of the magnet roller is rotated from the toner coating amount regulating member to a photosensitive drum, not a little nonmagnetic toner of a weak holding force is freed from the magnetic brush to be accumulated in the toner receiver. If the cleaning operation is repeated, the amount of accumulated toner only increases.

On the other hand, in the case of the magnetic toner, because of the application of a magnetic binding force, the amount of toner freed from the magnetic brush is small. Even if freed, the toner is recollected, and thus the toner accumulated in the toner receiver is never increased beyond a certain amount.

FIGS. 9, 10 and 11 show cases where toner coating amount regulating members are respectively a roller, a blade and a block. In these drawings, a reference numeral 5 denotes a magnet roller rotated in a direction of an arrow C. Similarly, a reference numeral 5a denotes a magnetic brush, 6 a waste toner carrying screw, 7 a cleaning blade, 8a a roller (toner coating amount regulating roller), 8b a blade (toner coating amount regulating blade), 8c a block (toner coating amount regulating block), 15 a photosensitive member (image bearing member, photosensitive drum) rotated in a direction of an arrow A, 25 a cleaning container, 28 a toner receiver, 29 a supporting member (also a wall member for separating the magnetic brush from a first waste toner carrying path), 32, 33 blades, and 25 the first waste toner carrying path.

In FIG. 9, if the toner coating amount regulating member is a roller 8a, the roller 8a is supported on both side walls of the cleaning container 25, and there are a blade 32 for scratching off toner scratched off by the roller 8a, and a blade 33 for preventing reverse flowing of the toner from the first waste toner carrying path 35 to the toner receiver 28. Besides, the supporting member 29 is present between the toner receiver 28 and the first waste toner carrying path 35 to support the blade 33. Thus, the nonmagnetic toner accumulated in the toner receiver 28 is eventually leaked from a gap between the photosensitive member 15 and the cleaning container 25, causing a phenomenon called dripping.

In the cases of FIGS. 10 and 11 where the toner amount regulating members are a blade 8b and a block 8c, similarly, because of the presence of the supporting member 29 for supporting the blade 8n or a block itself, dripping eventually occurs.

### SUMMARY OF THE INVENTION

The present invention is a result of consideration given to the foregoing situation, and objects of the invention are to provide a cleaning apparatus capable of maintaining a stable cleaning function for a long time without any toner dripping, and an image forming apparatus.

According to a preferred embodiment for achieving the foregoing object, there is disclosed a cleaning apparatus which has cleaning means for cleaning a surface of an image bearing member, developer carrying means for carrying a developer cleaned by the cleaning means, a developer receiving member arranged below the cleaning means in a direction of gravity to receive the developer dropped from the cleaning means, and a developer carrying path for interconnecting the developer receiving member and the developer carrying means.

According to the other preferred embodiment, there is provided an image forming apparatus which has image forming means for forming an image on an image bearing member by a developer, transferring means for transferring a developer image on the image bearing member to a transferring medium, cleaning means for cleaning a surface of the image bearing member after the transferring, developer carrying means for carrying a developer cleaned by the cleaning means, a developer receiving member arranged below the cleaning means in a direction of gravity to receive the developer dropped from the cleaning means, and a developer carrying path for interconnecting the developer receiving member and the developer carrying means.

According to these embodiments, the accumulation of developers dropped from the cleaning means to the developer receiver is prevented, and thus it is possible to limit dripping of the developers from the cleaning portion to a minimum.

### BRIEF DESCRIPTION OF THE DRAWINGS

FIG. 1 is a vertical sectional view schematically showing a constitution of an image forming apparatus of the present invention.

FIG. 2 is an enlarged vertical sectional view of a cleaning apparatus.

FIG. 3 is a perspective view seen from a toner reception side explaining a second waste toner carrying path.

FIG. 4 is a view showing a shape of a surface of a beam portion for forming the second waste toner carrying path, which is parallel to a toner receiver.

FIG. 5 is a view showing another type of a toner coating amount regulating member.

FIG. 6 is a view showing a sheet material disposed at a tip of the toner receiver and brought into contact with a surface of a photosensitive drum.

FIG. 7 is a view showing a toner carrying screw and its rotational direction.

FIG. 8 is a view showing a toner carrying screw and its rotational direction in the case of another apparatus arrangement.

FIG. 9 is a vertical sectional view showing a constitution of a conventional cleaner where a toner coating amount regulating member is a roller-shaped member.

FIG. 10 is a vertical sectional view showing a constitution of a conventional cleaner where a toner coating amount regulating member is a blade-shaped member.

FIG. 11 is a vertical sectional view showing a constitution of a cleaner where a toner coating amount regulating member is a block-shaped member.

### DETAILED DESCRIPTION OF THE EMBODIMENTS

Next, the preferred embodiments of the present invention will be described with reference to the accompanying drawings. Portions denoted by similar reference numerals in the drawings denote similar components and functions, and repeated explanation thereof will be omitted as occasion demands.

Embodiment 1

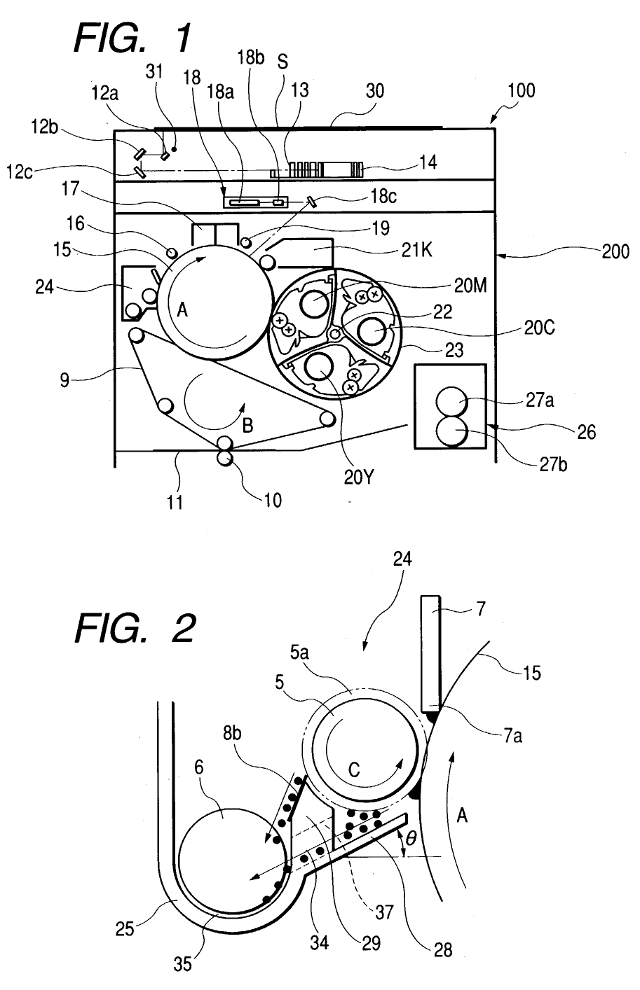

An example of an image forming apparatus of the present invention will be described by referring to FIGS. 1 to 8. However, it should be understood that the scope of the present invention is not limited to dimensions, materials, shapes, relative arrangements thereof, etc., unless specified otherwise.

The image forming apparatus shown in FIG. 1 is a color image forming apparatus of an electrophotographic system which can form full-color images of four colors, i.e., magenta (M), yellow (Y), cyan (C) and black (K). This image forming apparatus comprises a drum type electrophotographic photosensitive member (referred to as “photosensitive drum”, hereinafter) 15. An electrostatic latent image is formed on the photosensitive drum 15, toner is stuck to the electrostatic latent image to develop the image, and the developed toner image is transferred to a transferring material (e.g., sheet or transparent film), whereby a full-color image is formed.

An image reading portion 100 is installed in the upper part of an image forming apparatus main body. At the image reading portion, an original S placed on an original glass base 30 is exposed and scanned by an exposure lamp. Accordingly, a reflected light image from the original S is converged on a full-color sensor 14 by mirrors 12a, 12b and 12c and a lens 13 to obtain a color separation image signal.

The color separation image signal is passed through an amplifier circuit (not shown), processed by a video processing unit (not shown), and sent out to an image forming portion 200. At the image forming portion, when a signal of an image forming state is entered, the photosensitive drum 15 which is an image bearing member is first rotary-driven in an direction of an arrow A by driving means (not shown). Around the photosensitive drum 15, there are arranged a pre-exposure lamp 16, a corona electrifier 17, a laser exposure optical system 18 which is exposing means, a potential sensor 19, a cleaning apparatus (cleaner) 24, a fixed black developing device 21K, three rotatable color developing devices 20M, 20Y and 20C, and an intermediate transferring member (intermediate transferring belt) 9. The developing devices 20M, 20Y and 20C perform development in this order by toner of magenta, yellow and cyan. Incidentally, the color developing devices 20M, 20Y and 20C use nonmagnetic toner, while the black developing device 21K uses magnetic toner.

In the laser exposure optical system 18, the image signal from the image reading portion is converted into an optical signal at a laser output portion (not shown), the converted laser beam is reflected on a rotary polygon mirror 18a, and projected through a lens 18b and a mirror 18c to the surface (outer peripheral surface) of the photosensitive drum 15. In image formation, the photosensitive drum 15 is rotated in the direction of the arrow A, the photosensitive drum 15 discharged by the pre-exposure lamp 16 is uniformly charged to a predetermined polarity/potential by the corona electrifier 17, and the optical image is subjected to irradiation for each separation color, whereby an electrostatic latent image is formed.

Each of the color developing devices 20M, 20Y and 20C is detachably held by a developing rotary 23 rotated around a rotary shaft 22. In image formation, each developing device is rotated and moved around the rotary shaft 22 in the state of being held by the developing rotary 23, and the developing device used for development is stopped in a developing position opposite the photosensitive drum 15. Further, after a developing sleeve is positioned to face the photosensitive drum 13 by a very small gap, toner is stuck corresponding to the electrostatic latent image of the photosensitive drum 15 to develop a toner image.

In color image formation, the developing rotary 23 is rotated for each rotation of the intermediate transferring member 9 in a direction of an arrow B, and a developing process is carried out for the magenta developing device 20M, the yellowy developing device 20Y, the cyan developing device 20C and the black developing device 21K in this order.

The toner image made visible by each developing device on the photosensitive drum 15 is multi-transferred (primary transfer) four times (each image of four colors M, Y, C and K). Accordingly, the intermediate transferring member 9 is rotated in the direction of the arrow B in synchronization with an outer peripheral velocity of the photosensitive drum 15. Incidentally, for the photosensitive drum 15 after the primary transfer of the toner image, toner remaining (residual toner) on the surface of the photosensitive drum 15 without being transferred to the intermediate transferring member 9 is removed by the cleaning apparatus 24 for each primary transfer of the toner image of each color, and the photosensitive drum 15 is thereby set ready for forming a toner image of a next color.

The intermediate transferring member 9 to which the toner image has been multi-transferred holds a transferring material 11 between itself and a transferring roller 10 (secondary transferring roller) 10, and conveys it. Thus, the transferring material 11 receives simultaneous multi-transfer of the toner images of the respective colors on the intermediate transferring member 9, and then it is conveyed toward a fixing apparatus 26 for carrying out fixing of a next process.

The transferring material 11 holding the toner image on the surface conveyed to the fixing apparatus 26 is conveyed by a fixing roller 27a and a pressure roller 27b, heated and pressurized, whereby the toner image is fixed on the surface. After the toner image fixing, the transferring material 11 is discharged to the outside of the image forming apparatus main body. Thus, the image formation of the full-color images of the four colors is finished.

FIG. 2 is an enlarged explanatory view of the cleaning apparatus 24.

The reference numeral 8b in the drawing is a blade-shaped toner coating amount regulating member made of a nonmagnetic material. For example, it is constituted of a nonmagnetic metal blade (stainless or the like). The reference numeral 6 denotes a waste toner carrying screw (waste toner carrying means).

The cleaning blade 7 which base end side (upper end side in FIG. 2) is fixed to a part (not shown) of the cleaning container 25 presses one edge 7a of its tip side (lower end side in FIG. 2) into contact with the surface of the photosensitive drum 15, and scratches off residual toner left on the surface of the photosensitive drum 15 after transfer. The cleaning blade 7 is made of, for example a material having elasticity. For example, it may be made of urethane rubber or the like. The magnetic roller 5 is arranged on the upstream side of the cleaning blade 7 seen from a moving direction (direction of the arrow A) of the surface of the photosensitive drum 15. The magnet roller 5 is rotary-driven in a direction of an arrow C, and its surface is moved in the same direction as the moving direction (direction of the arrow A) of the surface of the photosensitive drum 15. As the magnetic toner and the nonmagnetic toner are supplied by the developing devices 20M, 20Y, 20C and 21K, a part of the collected magnetic toner (referred to as “collected toner” hereinafter as occasion demands) forms a magnetic brush 5a which is a toner layer of a certain thickness decided by the toner coating amount regulating member 8b on the surface of the magnet roller 5.

The toner coating amount regulating member 8b is arranged so that a thickness of the formed toner layer can be properly set larger than a minimum gap between the photosensitive drum 15 and the magnet roller 5. The toner layer reaches a position opposite the photosensitive drum 15 following rotation of the magnet roller 5 to carry out sure slide-rubbing on the surface of the photosensitive drum 15. The collected toner scratched off by the toner coating amount regulating member 8b is passed on the toner coating amount regulating member 8b and guided to the first waste toner carrying path 35. It is then carried in an axial direction by rotation of the waste toner carrying screw 6, and discharged to the outside.

The toner (mainly nonmagnetic toner) broken away while the magnetic brush 5a of the magnet roller 5 is rotated from the toner coating amount regulating member 8b to the photosensitive drum 15 drops onto the toner receiver 28 below the magnet roller 5. The toner receiver 28 has an inclination descending from the magnet roller 5 toward the first waste toner carrying path 35, and the nonmagnetic toner dropped to the toner receiver 28 is carried toward the first waste toner carrying path 25 by its own weight. Incidentally, toner carrying of the toner receiver 28 by its own weight can be effectively carried out by an inclination of about 20° from a horizontal direction as indicated by θ in FIG. 2.

Between the toner receiver 28 and the first waste toner carrying path 35, the supporting member 29 is disposed to project upward. This supporting member 29 supports the aforementioned toner coating amount regulating member 8b on its upper surface, and its lower part is supported by a plurality of toner reverse-flow preventing blades (beam portion) 34. The supporting member 29 is also a wall member for separating the toner receiver 28 from the first waste toner carrying path 35.

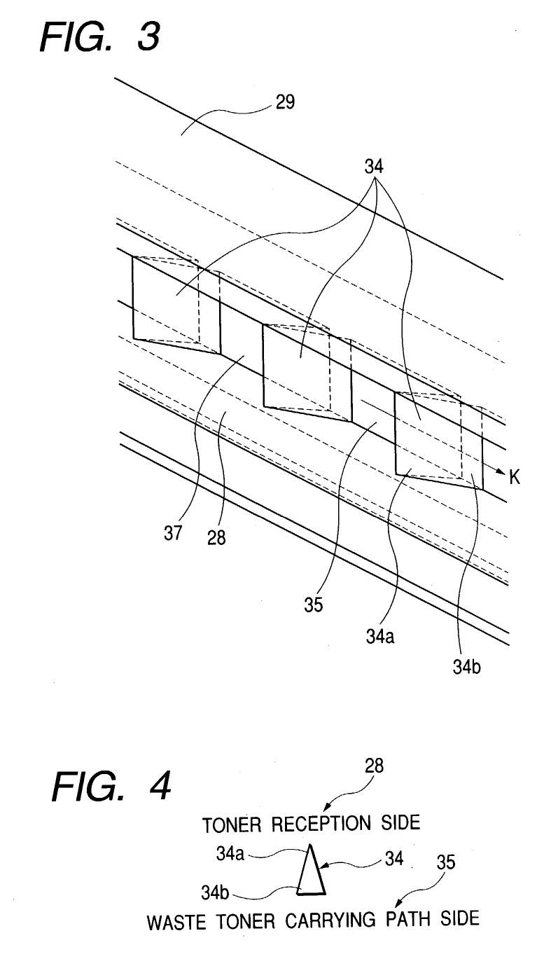

The plurality of toner reverse-flow preventing blades 34 form a ladder-shaped second waste toner carrying path 37 between the toner receiver 28 and the first waste toner carrying path 35. As shown in FIG. 3, the toner reverse-flow preventing blade 34 is constituted of a member having a wedge sectional shape (sectional shape parallel to the toner receiver 28) along a toner moving direction, and the plurality thereof are mounted in left and right directions (axial direction of the magnet roller 5). In the toner reverse-flow preventing blade 34, as shown in FIG. 4, a sharp tip 34a is directed to the toner receiver 28 side, and a wider base end 34b is directed to the first waste toner carrying path 35 side. Further, the toner reverse-flow preventing blade 34 may be mounted by being inclined in a direction perpendicular to a moving direction (direction of an arrow K in FIG. 3) of toner carried in the firs waste toner carrying path 35. That is, when seen from the direction of the arrow K, the toner reverse-flow preventing blade 34 is inclined so that the base end 34b is poisoned on the downstream side and the tip 34a is positioned on the upstream side. The second waste toner carrying path 37 is formed between the adjacent toner reverse-flow preventing blades 34, and the nonmagnetic toner carried from the toner receiver 28 by its own weight is smoothly moved to the first waste toner carrying path 35 without being blocked by the toner reverse-flow preventing blade 34 because of the wedge shape of the blade 34. Further, for the nonmagnetic toner which has passed through the toner reverse-flow preventing blade 34 and entered the first waste toner carrying path 35, since the toner reverse-flow preventing blade 34 is mounted by being inclined as described above, it is difficult to move from the first waste toner carrying path 35 to the toner receiver 28 side in the process of being carried in the direction of the arrow K by the waste toner carrying screw 6.

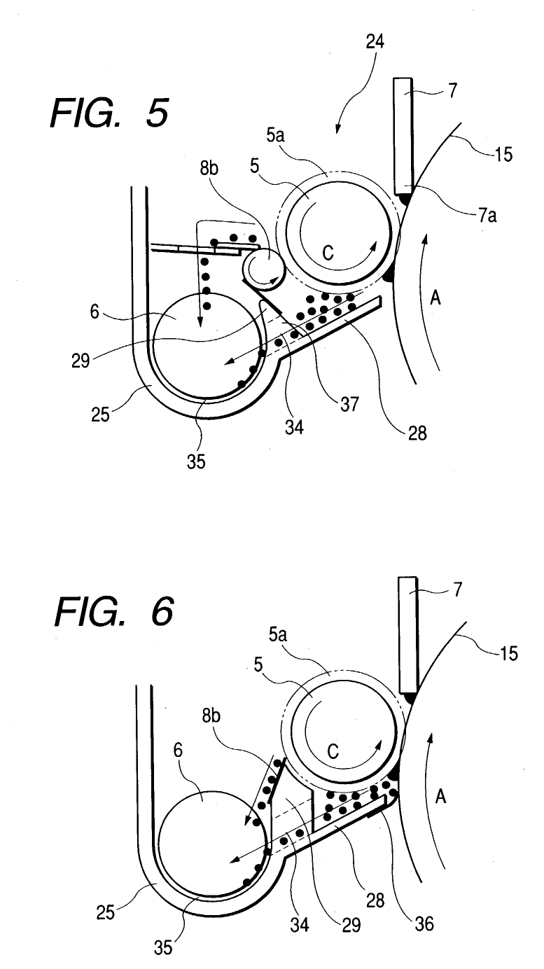

Additionally, as shown in FIG. 5, if the toner coating amount regulating member 8a is a roller, by providing the inclination of the toner receiver 28 and the second waste toner carrying path 37, even when the toner reversely flows from the first waste toner carrying path 35 toward the toner receiver 28, the toner is carried again to the first waste toner carrying path 35. Accordingly, the toner reverse-flow preventing blade 34 is not always necessary. However, preferably, the toner reverse-flow preventing blade 34 is disposed because such reverse-flowing toner has a direct effect on the magnetic brush 5a.

Further, by loading a sheet material 36 such as a urethane sheet from the toner receiver 28 on the photosensitive drum 15, it is possible to completely prevent dripping of toner from the cleaning container 25. This sheet material 36 is constituted of, for example a resin sheet of polyethylene terephthalate (PET) or urethane.

Furthermore, when the waste toner is discharged to the outside of the machine by the waste toner carrying screw 6, depending on a winding direction and a rotational direction of the waste toner carrying screw 6, there are a case where the waste toner is carried by being pressed to the outlet side of the second waste toner carrying path 37 and a case where the waste toner is carried by being pressed to the wall of the cleaning container 25 of the opposite side. If the amount of waste toner is large, when the waste toner is carried by being pressed to the outlet side of the second waste toner carrying path 37, there is a possibility of closing of the outlet by the waste toner or its reverse-flowing.

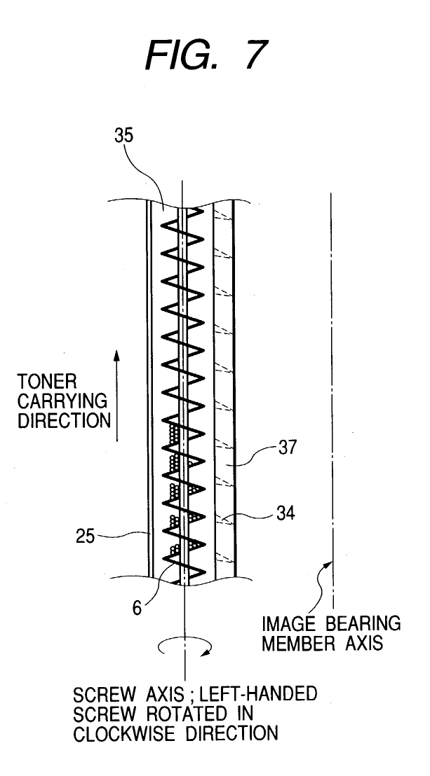

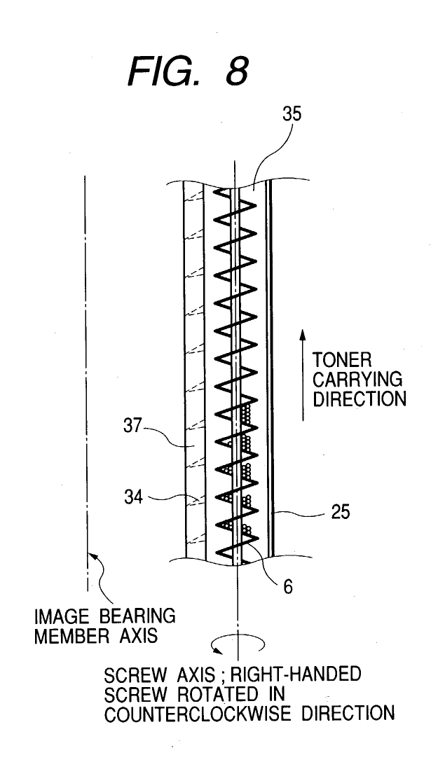

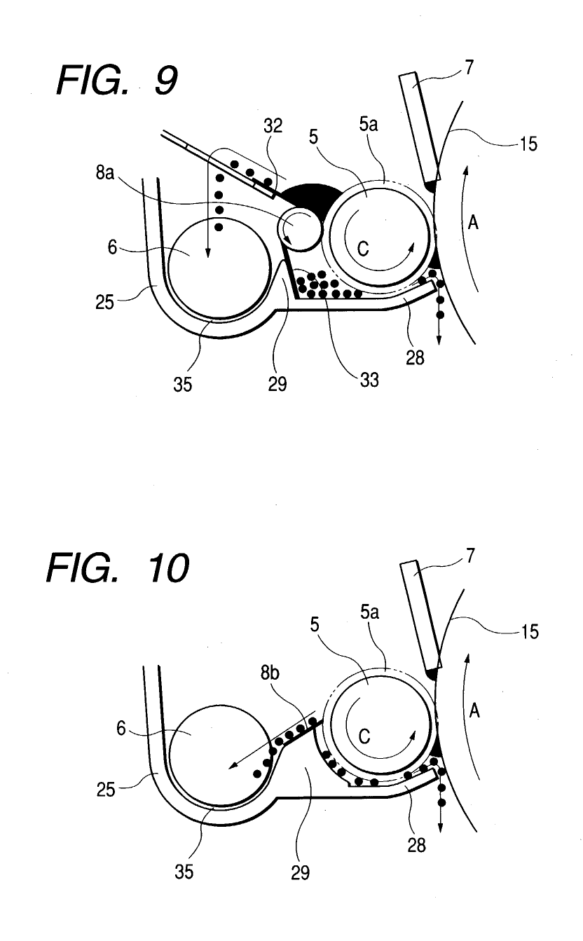

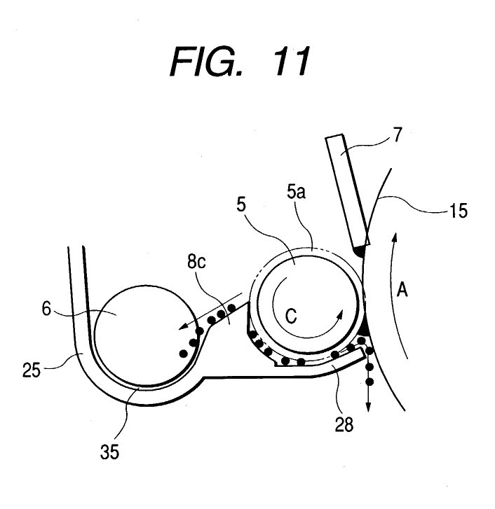

Thus, if the cleaning apparatus 24 is arranged to the left of the photosensitive drum 15 as in the embodiment shown in FIGS. 1 and 2, as shown in FIG. 7, the waste toner carrying screw 6 is wound counterclockwise, and its rotational direction is clockwise. On the other hand, if the cleaning apparatus 24 is arranged to the right of the photosensitive drum 15 (not shown), as shown in FIG. 8, the waste toner carrying screw 6 is wound clockwise, and its rotational direction is counterclockwise. According to this constitution, since the carried toner approaches a side opposite the outlet of the second waste toner carrying path 37 by the carrying operation of the screw, the waste toner can be discharged to the outside of the machine without closing the outlet of the second waste toner carrying path 37, and without any reverse-flowing from the second waste toner carrying path.

The embodiment has been described by way of example where the toner coating amount regulating member is blade-shaped. However, while the foregoing basic constitution is maintained, a roller-shaped or block-shaped toner coating amount regulating member can be used. In this case, effects similar to the foregoing can be obtained. However, in the case of the block-shaped member, the member itself is equivalent to the supporting member of the embodiment.

What is claimed is:

1. A cleaning apparatus comprising:
cleaning means for cleaning a surface of an image bearing member;
developer carrying means for carrying a developer cleaned by said cleaning means;
a developer receiving member arranged below said cleaning means in a direction of gravity to receive the developer dropped from said cleaning means; and
a developer carrying path for interconnecting said developer receiving member and said developer carrying means.

2. The cleaning apparatus according to claim 1, further comprising a wall member for separating said developer receiving member from said developer carrying means,
wherein said developer carrying path is disposed in said wall member.

3. The cleaning apparatus according to claim 1, wherein said developer receiving member is disposed by being inclined in a horizontal direction.

4. The cleaning apparatus according to claim 3, wherein said developer carrying path is disposed by being inclined in the horizontal direction.

5. The cleaning apparatus according to claim 4, wherein an inclined angle of said developer receiving member and an inclined angle of said developer carrying path are approximately equal to each other.

6. The cleaning apparatus according to claim 3, wherein the inclined angle of said developer receiving member in the horizontal direction is 20° or higher.

7. The cleaning apparatus according to claim 1, wherein said cleaning means has a magnet roller.

8. The cleaning apparatus according to claim 1, wherein said cleaning means has a magnet roller, a regulating member for regulating the amount of developer bound by the magnet roller, and a supporting member for supporting the regulating member, and said developer carrying path is disposed in the supporting member.

9. The cleaning apparatus according to claim 1, wherein said cleaning means has a magnet roller, a roller-shaped regulating member for regulating the amount of developer bound by the magnet roller, a developer removing member for removing the developer on the roller-shaped regulating member, and a supporting member for supporting the developer removing member, and said developer carrying path is disposed in the supporting member.

10. The cleaning apparatus according to claim 1, wherein a plurality of beam portions are disposed in said developer carrying path.

11. The cleaning apparatus according to claim 10, wherein a section of the beam portion on a plane has a shape in which a width of a side close to said developer carrying means is larger than a width of a side close to said developer receiving member.

12. The cleaning apparatus according to claim 11, wherein the section has a wedge shape.

13. The cleaning apparatus according to claim 1, wherein said developer carrying means has a rotary developer carrying member of a screw type, and the rotary developer carrying member has a screw shape and a rotational direction so that deviation of the developer with respect to a rotary shaft caused during carrying by the rotary developer carrying member occurs in a side farther than said developer carrying path.

14. The cleaning apparatus according to claim 1, wherein in said developer receiving member, a leakage preventing member is disposed to prevent leakage of the developer.

15. An image forming apparatus comprising:
image forming means for forming an image on an image bearing member by a developer;
transferring means for transferring a developer image on the image bearing member to a transferring medium;
cleaning means for cleaning a surface of the image bearing member after the transferring;
developer carrying means for carrying a developer cleaned by said cleaning means;
a developer receiving member arranged below said cleaning means in a direction of gravity to receive the developer dropped from said cleaning means; and
a developer carrying path for interconnecting said developer receiving member and said developer carrying means.

16. The image forming apparatus according to claim 15, further comprising a wall member for separating said developer receiving member from said developer carrying means,
wherein said developer carrying path is disposed in said wall member.

17. The image forming apparatus according to claim 15, wherein said developer receiving member is disposed by being inclined in a horizontal direction.

18. The image forming apparatus according to claim 17, wherein said developer carrying path is disposed by being inclined in the horizontal direction.

19. The image forming apparatus according to claim 18, wherein an inclined angle of said developer receiving member and an inclined angle of said developer carrying path are approximately equal to each other.

20. The image forming apparatus according to claim 17, wherein the inclined angle of said developer receiving member in the horizontal direction is 20° or higher.

21. The image forming apparatus according to claim 15, wherein said cleaning means has a magnet roller.

22. The image forming apparatus according to claim 15, wherein said cleaning means has a magnet roller, a regulating member for regulating the amount of developer bound by the magnet roller, a developer removing member for removing the developer on the roller-shaped regulating member, and a supporting member for supporting the regulating member, and said developer carrying path is disposed in the supporting member.

23. The image forming apparatus according to claim 15, wherein said cleaning means has a magnet roller, a roller-shaped regulating member for regulating the amount of developer bound by the magnet roller, a developer removing member for removing the developer on the roller-shaped regulating member, and a supporting member for supporting the developer removing member, and said developer carrying path is disposed in the supporting member.

24. The image forming apparatus according to claim 15, wherein a plurality of beam portions are disposed in said developer carrying path.

25. The image forming apparatus according to claim 24, wherein a section of the beam portion on a plane has a shape in which a width of a side close to said developer carrying means is larger than a width of a side close to said developer receiving member.

26. The image forming apparatus according to claim 25, wherein the section has a wedge shape.

27. The image forming apparatus according to claim 15, wherein said developer carrying means has a rotary developer carrying member of a screw type, and the rotary developer carrying member has a screw shape and a rotational direction so that deviation of the developer with respect to a rotary shaft caused during carrying by the rotary developer carrying member occurs in a side farther than said developer carrying path.

28. The image forming apparatus according to claim 15, wherein in said developer receiving member, a leakage preventing member is disposed to prevent leakage of the developer.

29. The image forming apparatus according to claim 15, wherein said image forming means is constituted to use, a plurality of kinds of developers, and at least one kind of developer has magnetism.
